(19) United States
(12) Patent Application Publication
(10) Pub. No.: US 2010/0075883 A1
(43) Pub. Date: Mar. 25, 2010

(54) GRANULAR CLEANING AND DISINFECTING COMPOSITION

(75) Inventors: Laurence Geret, Pulheim (DE); Michael Decker, Solingen (DE)

Correspondence Address: ECOLAB INC., MAIL STOP ESC-F7, 655 LONE OAK DRIVE, EAGAN, MN, 55121, US

(73) Assignee: ECOLAB INC., St. Paul, MN (US)

(21) Appl. No.: 12/236,663

(22) Filed: Sep. 24, 2008

(51) Int. Cl. C11D 3/10

(52) U.S. Cl. 510/161; 510/375; 510/378; 510/218

(57) ABSTRACT

The present invention relates to a granular cleaning and disinfecting composition generating a peroxy acid upon dissolution in water comprising: (1) 15-60 wt % of a percarbonate, (2) 8-35 wt % of an acylating agent, (3) 0.5-5 wt % a nonionic surfactant, (4) 0.1-3 wt % of a phosphonate as a foam inhibitor, having a bulk density between 0.5 and 1.4 kg/L as well as a method for cleaning or disinfecting with a low-foaming peroxy acid containing use solution obtained upon dissolution of the granular composition in water.

### FIELD OF THE INVENTION

The present invention relates to a granular cleaning and disinfecting composition generating a peroxy acid containing use solution upon dissolution in water as well as a method for cleaning or disinfecting with a low-foaming peroxy acid containing use solution obtained upon dissolution of the granular composition in water.

### BACKGROUND OF THE INVENTION

Disinfectants play an important role in an increasing number of industries, and numerous chemical disinfectants have been proposed over the years. Preparations based on aldehydes have been employed as chemical disinfectants in various fields. Most of these aldehyde-based compositions, however, possess disadvantages. Many aldehydes are volatile sensitisers and are irritant to the skin, eyes, and respiratory tract. A further drawback of aldehyde-based compositions is that they cannot be used for disinfecting objects soiled with organic material since aldehydes tend to denature and coagulate protein material, fixing it on the object to be cleaned, which results in biofilm formation on the object to be disinfected.

Organic peroxy acids, on the other hand, have numerous advantageous properties for the use as disinfectants. In particular peracetic acid possesses a broad spectrum of biological activity including bactericidal, fungicidal, biocidal, and sporicidal activity over a wide temperature range and even at low temperatures. Furthermore, peracetic acid is not deactivated by catalase and peroxidase, the enzymes breaking down hydrogen peroxide. It does not coagulate or fix tissues to surfaces, and breaks down to food-safe and environmentally friendly residues (acetic acid, water and oxygen). In addition, it remains active over a wide pH-range and can also be employed in hard water conditions. Solutions of peracetic acid are most commonly prepared from hydrogen peroxide and acetic acid.

However, a general problem with many active chemical disinfectants, also peroxy acids, is the long-term stability of the disinfectant. In many cases the functional group being responsible for the activity of a molecule also renders the molecule inherently unstable. Even equilibrium systems of peracetic acid (PAA) are thermodynamically unstable decomposing into acetic acid, water and oxygen. Especially in concentrated solutions of peracetic acid decomposition may occur rapidly. Further disadvantages of concentrated solutions of peracetic acid are the strong smell and the highly acidic pH which makes these solutions corrosive to surfaces and accounts for the special requirements in transport and storage.

To avoid these problems several systems have been developed to generate peroxy acids and, in particular, peracetic acid in situ from more stable precursors by reacting a suitable peroxide source with a peroxy acid precursor (activator). This has been realised, for example, by two-part systems wherein the peroxide source and the activator are provided in two separate containers and are mixed just prior to use.

More comfortable are “one-part” solid compositions containing both a peroxide and an acylating agent (activator) which upon dissolution in water react to form the peroxy acid in situ. To achieve a good stability in storage it is important to use stable precursors which do not react or decompose in the solid composition. On the other hand, both precursors have to dissolve rapidly in water to achieve the desired disinfectant concentration in a short time. A further advantage of solid composition which generate the peroxy acid in situ is the fact that additional compounds may be comprised in the composition which would not be stable in concentrated acidic solutions.

DE 102 14 750 A1 and CA 2569025 describe a finely powdered peracid generating systems that dissolves in water. A rapid and residue-free dissolution in water is a prerequisite for the use of a composition to avoid clogging (for example in channels, tubes, and cannulas in narrow-lumened medical instruments such as endoscopes). For this purpose, it is also of importance that the use solution obtained from the solid composition is low-foaming to avoid insufficient cleaning in the narrow spaces. In addition, especially in manual cleaning and disinfecting processes, visual inspection of the progress of cleaning is desirable which would be hampered by a strong foam formation. If machine cleaning equipment is used for the cleaning and disinfecting process foaming of the solutions can cause an interruption of the process.

Sodium perborate, especially sodium perborate tetrahydrate and sodium perborate monohydrate may be used as a peroxide source. But, perborates may be converted into phytotoxic borone in the aquatic environment and has to be replaced due to environmental and health concerns.

Sodium percarbonate (2Na₂CO₃×3H₂O₂) has been proposed as an alternative to solid peroxide. Although it has a respectable dissolution rate in water it is less widely used due to its lower storage stability, decomposing into sodium carbonate, water and oxygen. The reaction is catalysed by water, heat, and in the presence of organics and metal ions. Especially during bulk storage self-accelerating decompositions may occur. If percarbonate is used in powdered form high amounts of stabilizers are necessary which reduces the active oxygen content and further reduces the solubility of the compound. For this reason sodium percarbonate is commercially available commonly in a stabilised form, most commonly as a coated granulate. Several coatings have been proposed, for example water-insoluble coatings or boron silicate both of which are not suitable for the intended use in water-soluble, essentially borate-free cleaning and disinfecting compositions. In addition, most of the coated percarbonates commercially available cannot be used in granular cleaning and disinfecting compositions due to a slow dissolution rate in water, incomplete dissolution, and causing a cloudiness of the solution in usage concentration.

In comparison to powdered compositions, granular compositions offer the possibility of achieving a high bulk density and a low amount of dust emission. A severe obstacle, however, is that many acylating agents such as, for example, tetraacetyl ethylendiamine (TAED) are sparingly soluble in water. In powdered compositions an acceptable rate of dissolution is achieved by using finely divided TAED. However, in combination with a granular peroxide, the use of powdered TAED would result in segregation of the components during transport and storage.

A further problem associated with the use of percarbonates as a peroxide source is the gas formation (gasing) accompanying the peroxy acid generating reaction of the percarbonate and the acylating agent in water. This gasing is not observed when perborate is used as a peroxide. As a result foam formation is observed in the presence of surfactants, even if low-foaming surfactants are used, which is detrimental especially in cleaning or disinfecting narrow-lumened medical instruments such as endoscopes or if a visual inspection of the objects to be cleaned or disinfected is desired. On the other hand, especially in cleaning and disinfecting sensitive medical instruments in contact with blood and tissue, additional surfactants are necessary to ensure a thorough cleaning and disinfecting on a reasonable time scale.

Accordingly, it was an object of the present invention to provide a granular cleaning and disinfecting composition, which is both stable in storage and transport, comprising a percarbonate which rapidly and sediment-free dissolves in water generating a low-foaming peroxy acid containing use solution.

This object has been achieved by the compositions according to the present invention.

### SUMMARY OF THE INVENTION

It has surprisingly been found, that the presence of phosphonates reduces the gas formation accompanying the peroxy acid generating reaction of percarbonate and an acylating agent in water. As a consequence, surfactants may be present in the inventive compositions obtained thereof without facing the problem of foam formation which is detrimental especially in cleaning or disinfecting narrow-lumened medical instruments such as endoscopes or if a visual inspection of the objects to be cleaned or disinfected is desired. As a major advantage, readily soluble TAED-granulates coated with non-ionic surfactants may be used as a precursor for peracetic acid.

### BRIEF DESCRIPTION OF THE DRAWINGS

FIG. 1 shows the apparatus used in the lab testing to monitor the gas generation of the use solution comprising a flask containing the use solution connected to a gas pipe reaching into a water-filled graduated volumetric burette in which the gas generated is being collected and measured.

FIG. 2 shows the influence of the presence of phosphonate on gasing in peracetic acid-containing use solutions obtained from the compositions according to the present invention. The solid graph shows the volume of gas generated in a 2 wt % use solution containing phosphonate as a foam inhibitor (composition 2), while the dotted line represents the increase in volume due to gas formation in a 2 wt % use solution containing no phosphonate (composition 3).

FIG. 3 shows the amount of peracetic acid in ppm contained in a 2 wt % use solution over several hours.

### DETAILED DESCRIPTION OF THE INVENTION

### Granular Compositions

The present invention provides granular cleaning and disinfecting compositions generating a peroxy acid containing use solution upon dissolution in water comprising:

(1) 15-60 wt % of a percarbonate,

(2) 8-35 wt % of an acylating agent,

(3) 0.5-5 wt % of a nonionic surfactant, and

(4) 0. 1-3 wt % of a phosphonate as a foam inhibitor,

the composition having a bulk density between 0.5 and 1.4 kg/L.

“Granular” means that the compositions according the present invention are essentially dust-free, thus the amount of particles having a particle size smaller than 0.1 mm is less than 3 wt %. In a preferred embodiment the amount of particles having a particle size smaller than 0.2 mm is less than 15 wt % and more than 40 wt % of the particles have a particle size between 0.4 and 0.8 mm. The amount of particles having a particle size greater than 1.6 mm is preferably below 1%.

The compositions according to the present invention are free-flowable stable granulates, neither decomposing in storage nor segregating in transport, which have a high bulk density thus reducing the expenses for transport and storage and show essentially no dust emission. They dissolve rapidly (within 15 min) and are sediment-free in water, generating a low-foaming peroxy acid cleaning or disinfecting use solution.

In a preferred embodiment the composition according to the present invention comprises:

(1) 20-45 wt % of a percarbonate,

(2) 15-25 wt % of an acylating agent,

(3) 1-3 wt % a nonionic surfactant, and

(4) 0.5-2 wt % of a phosphonate.

The bulk density is defined as the ratio of the mass of a material to the total volume the material occupies. The bulk density was determined according to DIN ISO 697 and DIN 53466. Accordingly, a high bulk density reduces the costs for transport and storage. The composition according to the present invention has a bulk density preferably between 0.7 and 1.4 kg/L, more preferably between 0.8 and 1.2 kg/L and most preferred between 0.8 and 1.0 kg/L.

In a preferred embodiment the composition comprises a mixture of at least two granulates, wherein one granulate comprises the percarbonate and the other granulate comprises the acylating agent.

It is further preferred that the granulate comprising a percarbonate is coated with a water-soluble inorganic salt and that the granulate comprising the acylating agent is coated with a water-soluble surfactant. Using a water-soluble surfactant as a coating for the granulate comprising the acylating agent, a high dissolution rate can be achieved. Also, the high bulk density of the product puts the percarbonate and the acylating agent into close contact and the two materials will react with each other in storage if they are not coated.

### Peroxy Acid

A peroxy acid is formed from the reaction of the percarbonate and the acylating agent. The peroxy acid generated is preferably selected from the group of C₂-C₁₀ alkyl peroxy acids, more preferably from the group of peracetic acid, perpropionic acid, peroctanoic acid, perdecanoic acid, or mixtures thereof. Most preferably the peroxy acid generated is peracetic acid or peroctanoic acid or a mixture.

### Percarbonate

The composition includes a peroxygen source to react with a peracid precursor, in this case the acylating agent, to provide the peracid sanitizer solution. Preferably, the peroxygen source does not react with the peracid precursor until it is desirable for the components to react together. It is generally desirable for the peroxygen source and the peracid precursor to react together when added to water. In addition, the peroxygen source is preferably one which will react with the peracid precursor to provide a peracid reaction product which is soluble in water. The peroxygen source can include inorganic persalts such as sodium perborate, sodium percarbonate, calcium peroxide, sodium peroxide, sodium persulfate, perhydrate of urea, and mixtures thereof. Preferred peroxygen sources include percarbonates such as sodium percarbonate (2Na₂CO₃.3H₂O₂).

The peroxygen source is preferably provided in an amount which will provide a desired level of peracid in the peracid sanitizer for achieving a desired level of sanitizing, disinfecting, and/or bleaching when combined with acid precursor and water. In general, it is expected that the peroxygen source will be provided in an amount of between about 15 to 60 wt %, more preferably from 20 to 45 wt %.

The peroxygen source may be coated. The coating is preferably a water soluble inorganic salt. Examples of suitable inorganic salts include sodium sulphate, sodium carbonate, and boron silicate.

### Acylating Agent

The peracid precursor, in this case the acylating agent, and the peroxygen source are reactive, in the presence of water, to provide an aqueous peracid solution. The acylating agent preferably remains in solid form at temperatures up to about 40° C. so that under conditions often encountered during transportation and storage, the acylating agent will remain a solid and will resist reacting with the peroxygen source until a fluid such as water is introduced. Furthermore, the acylating agent should be one which, when reacted with the peroxygen source, provides a peracid which is soluble in water. Because the acylating agent and the peroxygen source can be provided together within a permeable container or together in a composite structure, it is desirable that they do not react together until a fluid such as water is introduced.

The acylating agent is preferably an organic acid. Preferred acylating agents are compounds containing at least one acyl group which is susceptible to perhydrolysis. Suitable acylating agents are those of the N-acyl, or O-acyl compound type containing an acyl radical, R—CO— wherein R is an aliphatic group having from 5 to 18 carbon atoms, or an alkylaryl of about 11 to 24 carbon atoms, with 5 to about 18 carbon atoms in the alkyl chain. If the radicals are aliphatic, they preferably contain 5 to 18 carbon atoms and most preferably 5 to 12 carbon atoms. In a preferred embodiment the acylating agent is selected from the group containing tetraacetyl glycoluril (TAGU), tetraacetyl ethylendiamine (TAED), diacetyl dioxohexahydratriazine (DADHT), and mixtures thereof.

The acylating agent is preferably provided in an amount which will provide a desired level of peracid for achieving a desired level of sanitizing, disinfecting, or bleaching when combined with a peroxygen source and water. In general, it is expected that the acylating agent will be provided in an amount of between about 8 to 35 wt %, more preferably from 15 to 25 wt %.

In order to increase the shelf life of the acylating agent in the composition containing the peroxygen source, it may be desirable to coat the acylating agent with a coating that provides a gas or moisture barrier. The acylating agent can be coated or granulated using conventional technology generally known in the coating and granulation art. Water soluble coatings are preferably a surfactant such as a nonionic surfactant. Examples of suitable nonionic surfactant coatings are listed in the nonionic surfactant section.

### Nonionic Surfactant

The composition includes at least one nonionic surfactant. Nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water soluble compound having the desired degree of balance between hydrophilic and hydrophobic properties. Nonionic surfactants include:

1. Block polyoxypropylene-polyoxyethylene polymeric compounds based upon propylene glycol, ethylene glycol, glycerol, trimethylolpropane, and ethylenediamine as the initiator reactive hydrogen compound. Examples of polymeric compounds made from a sequential propoxylation and ethoxylation of initiator are commercially available under the trade names Pluronic® and Tetronic® manufactured by BASF Corp.

Pluronic compounds are difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule.

Tetronic compounds are tetra-functional block copolymers derived from the sequential addition of propylene oxide and ethylene oxide to ethylenediamine. The molecular weight of the propylene oxide hydrotype ranges from about 500 to about 7,000; and, the hydrophile, ethylene oxide, is added to constitute from about 10% by weight to about 80% by weight of the molecule.

2. Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

3. Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range or it can consist of an alcohol having a specific number of carbon atoms within this range. Examples of like commercial surfactant are available under the trade names Neodol® manufactured by Shell Chemical Co. and Alfonic® manufactured by Vista Chemical Co. 4. Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the above defined carbon atoms range or it can consist of an acid having a specific number of carbon atoms within the range. Examples of commercial compounds of this chemistry are available on the market under the trade names Nopalcol® manufactured by Henkel Corporation and Lipopeg® manufactured by Lipo Chemicals, Inc.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols have application in this invention. All of these ester moieties have one or more reactive hydrogen sites on their molecule which can undergo further acylation or ethylene oxide (alkoxide) addition to control the hydrophilicity of these substances.

Examples of nonionic low foaming surfactants include:

5. Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. These reverse Pluronics® are manufactured by BASF Corporation under the trade name Pluronic® R surfactants.

Likewise, the Tetronic® R surfactants are produced by BASF Corporation by the sequential addition of ethylene oxide and propylene oxide to ethylenediamine. The hydrophobic portion of the molecule weighs from about 2,100 to about 6,700 with the central hydrophile including 10% by weight to 80% by weight of the final molecule.

6. Compounds from groups (1), (2), (3) and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional examples of effective low foaming nonionics include:

7. The alkylphenoxypolyethoxyalkanols of U.S. Pat No. 2,903,486 issued Sep. 8, 1959 to Brown et al. and represented by the formula

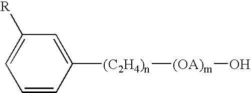

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7 1968 to Lissant et al. having the general formula Z[(OR)ₙOH]_{z} wherein Z is alkoxylatable material, R is a radical derived from an alkaline oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954 to Jackson et al. corresponding to the formula Y(C₃H₆O)ₙ(C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ(C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerine, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents correspond to the formula: P[(C₃H₆O)ₙ(C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

8. Polyhydroxy fatty acid amide surfactants include those having the structural formula R²CONR¹Z in which: R1 is H, C₁-C₄ hydrocarbyl, 2-hydroxy ethyl, 2-hydroxy propyl, ethoxy, propoxy group, or a mixture thereof, R₂ is a C₅-C₃₁ hydrocarbyl, which can be straight-chain; and Z is a polyhydroxyhydrocarbyl having a linear hydrocarbyl chain with at least 3 hydroxyls directly connected to the chain, or an alkoxylated derivative (preferably ethoxylated or propoxylated) thereof Z can be derived from a reducing sugar in a reductive amination reaction; such as a glycityl moiety.

The alkyl ethoxylate condensation products of aliphatic alcohols with from about 0 to about 25 moles of ethylene oxide. The alkyl chain of the aliphatic alcohol can either be straight or branched, primary or secondary, and generally contains from 6 to 22 carbon atoms.

10. The ethoxylated C₆-C₁₈ fatty alcohols and C₆-C₁₈ mixed ethoxylated and propoxylated fatty alcohols. Ethoxylated fatty alcohols include the C₁₀-Cl₈ ethoxylated fatty alcohols with a degree of ethoxylation of from 3 to 50.

11. Nonionic alkylpolysaccharide surfactants are disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

12. Fatty acid amide surfactants include those having the formula: R⁶CON(R⁷)₂ in which R⁶ is an alkyl group containing from 7 to 21 carbon atoms and each R⁷ is independently hydrogen, C₁-C₄ alkyl, C₁-C₄ hydroxyalkyl, or —(C₂H₄O)ₓH, where x is in the range of from 1 to 3.

13. Another class of nonionic surfactants include the class defined as alkoxylated amines or, most particularly, alcohol alkoxylated/aminated/alkoxylated surfactants. These nonionic surfactants may be at least in part represented by the general formulae:

R²⁰—(PO)ₛN—(EO)ₜH,

R²⁰—(PO)ₜN—(EO)ₜH(EO)ₜH, and

R²⁰—N(EO)ₜH;

in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula:

R²⁰—(PO)ᵥ—N[(EO)_{w}H][(EO)_{z}H]

in which R²⁰ is as defined above, v is 1 to 20 (e.g., 1, 2, 3, or 4 (preferably 2)), and w and z are independently 1-10, preferably 2-5.

These compounds are represented commercially by a line of products sold by Huntsman Chemicals as nonionic surfactants. A preferred chemical of this class includes Surfonic™ PEA 25 Amine Alkoxylate.

The treatise Nonionic Surfactants, edited by Schick, M. J., Vol. 1 of the Surfactant Science Series, Marcel Dekker, Inc., New York, 1983 is an excellent reference on the wide variety of nonionic compounds generally employed in the practice of the present invention. A typical listing of nonionic classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch).

The nonionic surfactant is preferably solid at 25° C. A preferred nonionic surfactant is a water-soluble ethoxylated tallow fatty acid solid at 25° C. The amount of the nonionic surfactant comprised in the composition is preferably 0.5 to 5 wt %, more preferably 1-3 wt % and most preferably 2 wt %.

### Phosphonate

The composition includes at least one phosphonate. The phosponate is preferably selected from the group containing 1-hydroxyethane(1,1-diylbiphosphonic acid) (HEDP), nitrilotris(methylenephosphonic acid) (NTMP), diethylenetriaminepentakis(methylenephosphonic acid) (DTPMP), 1,2-diaminoethanetetrakis(methylenephosphonic acid) (EDTMP), their sodium, potassium or ammonium salts, or mixtures thereof. Most preferably the phosphonate is HEDP. The amount of phosphonate present in the composition according to the present invention preferably is 0.1-3 wt %, more preferably 0.5-2 wt %, and most preferably 1 wt %.

### Additional Materials

The composition may contain one or more additional compounds selected from the group of alkalising agents such as sodium carbonate, buffer systems such a sodium bicarbonate or citric acid anhydrate, complexing agents, corrosion inhibitors such as benzotriazole, granulation auxiliaries, perfume, dyes, solubilizers, and further surfactants.

By using suitable buffer systems, it is possible to ensure a stable pH in the use solution obtained by dissolving a certain amount of the granular composition in water without the need for adjusting the pH of the use solution. Preferred embodiments include for example compositions, wherein the pH of a 2 wt % use solution is from about pH 8 to about pH 10, and stable for at least 24 h, i.e. not deviating from the pH of the initial use solution for more than pH ±b 0.2.

The composition is preferably free of perborate for the environmental and health concerns discussed above. But, the composition may include small amounts of perborate, for example less than 5.3 wt %, calculated for the theoretical “pure sodium perborate” (“NaBO₄”). When calculated as the amount of sodium perborate monohydrate, the amount in the composition is preferably less than 6.5 wt % or 0.1 wt % and the amount of sodium perborate tetrahydrate is less than 10 wt %. More preferably the amount of sodium perborate is less than 0.1 wt % and most preferably the composition is essentially perborate-free.

The present invention further provides a method for cleaning or disinfecting objects with a low-foaming peroxy acid containing use solution comprising:
(1) Preparing a use solution by dissolving the composition of the present invention in water;
(2) Contacting the object to be cleaned or disinfected with the use solution, preferably by immersing the object into the use solution or by applying (for example by spraying) the use solution onto the surface of the object, for a time sufficient to allow for a satisfactory cleaning or disinfection; and
(3) Optionally rinsing the object.

This method can be used for cleaning and disinfecting medical, veterinary, live-stock, and food- and beverage-processing equipment and facilities, preferably for manually or automatically disinfecting medical instruments, most preferably endoscopes. The use solutions obtained from inventive composition are also suitable as a disinfecting agent in the field of fish-farming.

### EXAMPLES

### Example 1

### Preparation of Granular Compositions

Compositions 1, 2, and 3 were prepared by mixing the components listed in Table 1.

Compositions 1 and 2 are specific embodiments of the present invention, while composition 3 is a reference composition containing essentially the same components as composition 2, except that no phosphonate was added. The missing phosphonate was balanced with sodium carbonate.

TABLE 1

| | | | Composition 3 |
|---|---|---|---|
| | Composition | Composition | (reference |
| | 1 | 2 | composition) |
| Coated sodium carbonate | 40-50 | 10-20 | 10-22 |
| peroxyhydrate | | | |
| Sodium tripolyphosphate | — | 40-50 | 40-50 |
| Solid non-ionic surfactant | 1-3 | 1-3 | 1-3 |
| Sodium carbonate | 2-5 | 10-20 | 10-20 |
| Tetrasodium (1- | 0.5-2 | 0.5-2 | — |
| hydroxyethylidene) | | | |
| biphosphonate | | | |
| Corrosion inhibitor | 0.5-2 | 0.5-2 | 0.5-2 |
| Coated granular TAED | 20-25 | 12-18 | 12-18 |
| Liquid oxo alcohol EO-PO- | 0.5-2 | — | — |
| adduct | | | |
| Perfume | 0.01-0.2 | — | — |
| Sodium bicarbonate | 1-3 | — | — |
| Citric acid anhydrate | 12-18 | — | — |

All amounts listed in Table 1 are given in wt %

A 2 wt % use solution obtained from dissolving 20 g of composition 1 in 980 g of water had a pH 8, while the 2 wt % use solution obtained from dissolving 20 g of composition 2 in 980 g of water had a pH 9.9-10. The pH was stable for 24 h at room temperature.

### Example 2

### Particle Size Distribution

The particle size distribution of compositions 1 and 2 was determined by sieve analysis using an analytical sieving machine type LAVIB S+52 (Siebtechnik GmbH, Mülheim a. d. Ruhr). A set of five sieves with a mesh size of 1.6, 0.8, 0.4, 0.2, and 0.1 mm, respectively, was used. The sieves were arranged in descending mesh size. Exactly 100 g of the granular composition 1 or 2, respectively, were carefully loaded onto the uppermost sieve (mesh size 1.6 mm), then the set of sieves was closed and was vibrated for 120 seconds. Afterwards the residue amount held back on each sieves was rated. For each composition sieve analysis was carried out twice.

Table 2 gives the particle-size distribution of compositions 1 and 2 in weight percent as an average of two measurements.

TABLE 2

| | Composition 1 | Composition 2 |
|---|---|---|
| Sieve [mm] | residue [wt %] | residue [wt %] |
| 0 | 0.5 | 2.1 |
| 0.1 | 6.7 | 11.1 |
| 0.2 | 6.3 | 21.4 |
| 0.4 | 45 | 50.9 |
| 0.8 | 41.2 | 15.3 |
| 1.6 | 0.6 | 0.1 |

### Example 3

### Bulk Density

The bulk density of compositions 1 and 2 respectively was determined according to DIN ISO 697 and DIN 53466. Composition 1 has a bulk density of 800 g/L, while the bulk density of composition 2 is 900 g/L.

### Example 4

### Influence of the Phosphonate on Gas Generation in the Use Solution

Use solutions containing 2 wt % of compositions 2 and 3 respectively were prepared by dissolving 20 g the composition in 980 g of deionised water with stirring at 500 rpm for 15 minutes. Both mixtures completely dissolved without sediment within 15 minutes. 500 g of each use solution was then filled into a volumetric flask which was closed with a gas pipe. The open end of the gas pipe was introduced into a water-filled graduated volumetric burette in which the gas generated was collected and measured at room temperature. Table 2 lists the average values obtained from two determinations carried out for each sample.

Gas generation from a granular composition with and without phosphonate (composition 2 and 3).

TABLE 3

| | Composition 2 | Composition 3 |
|---|---|---|
| t [min] | average volume [mL] | average volume [mL] |
| 20 | 0.1 | 0.2 |
| 60 | 1.0 | 2.0 |
| 180 | 5.2 | 13.2 |
| 300 | 12.1 | 30.1 |

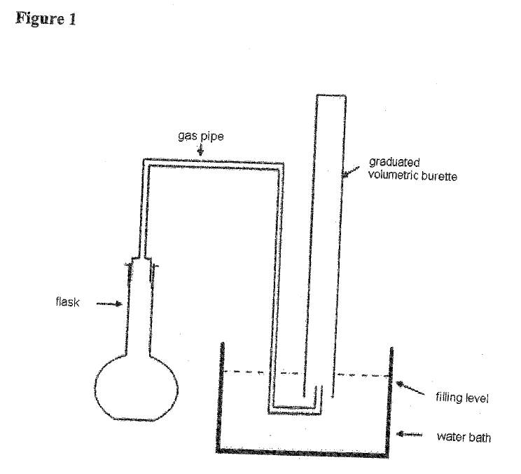

The apparatus used for determining the gas generation is depicted in FIG. 1.

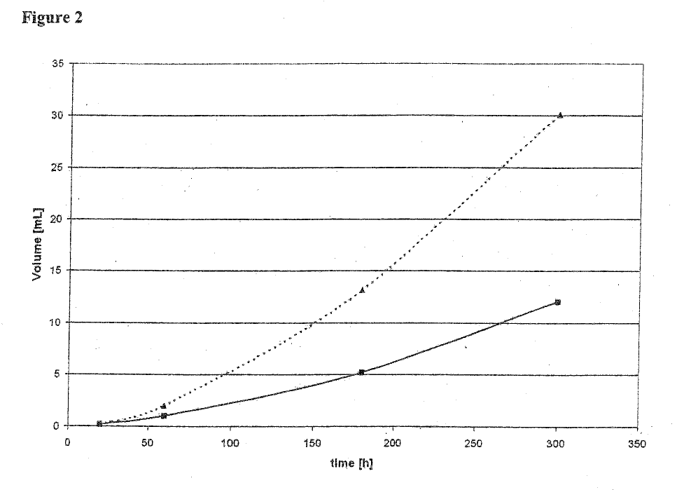

FIG. 2 shows the gas generation of compositions 2 and 3 in dependency on time.

### Example 5

### Visual Inspection of the Extent of Foam Formation in Relation to the Presence of Phosphonate in the Granular Mixture

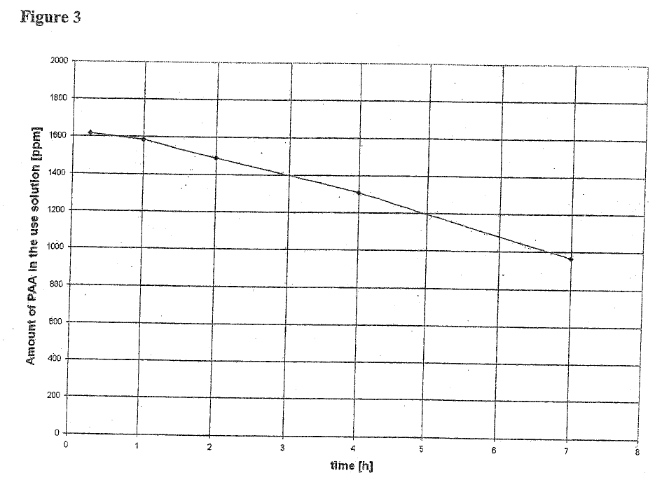

A 2 wt % use solution of compositions 2 and 3, respectively, was prepared according to the procedure described in Example 4. The on-top foam formation was evaluated visually (see also FIG. 3). The presence of phosphonate in the granular composition significantly reduces the on-top foam formation in the use solution which results from the gas formation accompanying the formation of peracetic acid from percarbonate and TAED in water.

### Example 6

### Comparison of the Amount of Peracetic Acid Generated

To evaluate the amount of peracetic acid generated in the 2 wt % use solutions of the granular compositions 2 and 3, respectively, were prepared according to example 4 except that tap water was used instead of deionised water. After 15 minutes at room temperature (20 to 26° C.) 25 g of the 2 wt % solution were added to a mixture of 100 g deionised water, 100 g ice made of deionised water, and 20 mL glacial acetic acid. A small spatula of potassium iodide was added and the solution was titrated under cool conditions with 0.1 N-sodiumthiosulfate solution until the colour changed from blackish-brown to yellow. 2 mL of a 1% starch solution in water was then added. As a result, the mixture turned dark again. Titration was being continued until the colour changed from black to colourless, and the endpoint was reached. The amount of peracetic acid in the use solution was then calculated according to the following formula:

amount of PAA [ppm]=A×38.0×f×4

wherein A represents the volume of the 0.1 N solution of sodium thiosulfate used in mL, and f represents the corrector factor for the 0.1 N solution of sodium thiosulfate. The amount of peracetic acid generated in the use solution obtained from composition 2 was 1.615 ppm, whilst the use solution obtained from composition 3 (reference composition without phosphonate) was 1.258 ppm.

### Example 7

The amount of peracetic acid in a 2 wt % use solution of composition 2 was determined according to example 6 after 1, 2, 4, and 7 hours. As can be gathered from FIG. 4 the maximum amount of peracetic acid is available only 15 minutes after dissolving the granular composition 2 in water. From that point on the amount of peracetic acid slowly but almost constantly decreases. After 24 hours 187 ppm peracetic acid are present in the remaining use solution. Since peracetic acid mainly decomposes to environmentally friendly acetic acid, water, and oxygen, no special waste treatment is required for excess use solution.

1. A cleaning and disinfectant composition, comprising:
(1) 15-60 wt % of a percarbonate,
(2) 8-35 wt % of an acylating agent,
(3) 0.5-5 wt % a non-ionic surfactant, and
(4) 0.1-3 wt % of a phosphonate as a foam inhibitor,
wherein the composition is comprised of a mixture of at least two granulates, the first granulate comprising a percarbonate coated with a water-soluble inorganic salt, the second granulate comprising an acylating agent coated with a water-soluble surfactant, the composition having a bulk density between 0.5 and 1.4 kg/L and the composition rapidly dissolves in water.

2. The composition of claim 1, wherein the composition comprises
(1) 20-45 wt % of a percarbonate,
(2) 15-25 wt % of an acylating agent,
(3) 1-3 wt % a non-ionic surfactant, and
(4) 0.5-2 wt % of a phosphonate.

3. The composition of claim 1, wherein the percarbonate is sodium percarbonate.

4. The composition of claim 1, wherein the peroxy acid generated is peracetic acid.

5. The composition of claim 1, wherein the acylating agent is selected from the group consisting of tetraacetyl glycoluril (TAGU), tetraacetyl ethylenediamine (TAED), diacetyl dioxohexahydratriazine (DADHT), and mixtures thereof.

6. The composition of claim 1, wherein the phosphonate is selected from the group containing 1-hydroxyethane(1,1-diphosphonic acid) (HEDP), nitrilotris(methylenephosphonic acid) (NTMP), diethylenetriaminepentakis(methylenephosphonic acid) (DTPMP), 1,2-diaminoethanetetrakis(methylenephosphonic acid) (EDTMP), their sodium, potassium or ammonium salts, or mixtures thereof.

7. (canceled)

8. (canceled)

9. (canceled)

10. The composition of claim 1, wherein the composition contains one or more additional compounds selected from the group of alkalising agents, buffer systems, complexing agents, corrosion inhibitors, granulation auxiliaries, perfume, dyes, solubilizers, further surfactants, and mixtures thereof.

11. The composition of claim 1, wherein the amount of sodium perborate comprised in the composition is less than 5.3 wt %.

12. A method for cleaning or disinfecting objects with a low-foaming peroxy acid containing use solution comprising:
(1) preparing a use solution by dissolving the composition of claim 1 in water; and
(2) contacting the object to be cleaned or disinfected with the use solution, by applying the use solution onto the surface of the object, for a time sufficient to allow for a satisfactory cleaning or disinfection.

13. The method of claim 12, wherein the object is located in a medical, veterinary, live-stock or food- and beverage-processing facilities.
